(19) United States
(12) Patent Application Publication
(10) Pub. No.: US 2003/0168491 A1
(43) Pub. Date: Sep. 11, 2003

(54) Upright nail gun and method therefor

(76) Inventor: Dewayne Goodwin, McDonough, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/091,764

(22) Filed: Mar. 6, 2002

(51) Int. Cl. B25C 1/00

(52) U.S. Cl. 227/147

(57) ABSTRACT

An upright nail gun and method therefore, wherein an elongated handle assembly having a trigger carried thereby is attached to or integrally formed with a nail gun thereby allowing a user to nail while in a standing position.

### TECHNICAL FIELD

The present invention relates generally to nail guns and more specifically, to an upright nail gun and method therefor.

### BACKGROUND OF THE INVENTION

From simple home construction and renovation to erecting large skyscrapers, nail guns powered by air, electricity or any other means have found popular use in almost any application. Although users of nail guns are generally pleased with a nail gun's overall efficiency and performance, some users find nail guns relatively heavy and awkward to operate. For instance, utilizing a nail gun often requires the user to frequently assume and maintain a kneeled or crouched position, usually imposing considerable stress on the user's knees and back. The result of such repetitive motions typically subjects the nail gun user to long-term bodily injury.

Moreover, utilizing a prior art nail gun in a kneeled or crouched position results in a less efficient process. For instance, after nailing in a certain position the user must then crawl, hop, scoot or re-stand and then re-kneel to the next position; consequently taking additional time and effort to perform the complete task.

Therefore, it is readily apparent that there is a need for an upright nail gun, wherein an individual is able to remain standing while operating the upright nail gun, thus reducing the aforementioned disadvantages.

### BRIEF SUMMARY OF THE INVENTION

Briefly described, in a preferred embodiment, the present invention overcomes the above-mentioned disadvantages and meets the recognized need for such a device by providing an upright nail gun, wherein an individual is able to remain standing while operating the upright nail gun, thus reducing the bodily injury often associated with operating a nail gun in a kneeled or crouched position and increasing the overall efficiency of the nailing process, thereby reducing the number of man-hours for a specified task.

According to its major aspects and broadly stated, the present invention in its preferred form is an upright nail gun and method therefor. More specifically, the present invention is a nail gun having an upright shaft, wherein the length of the shaft approximates the waist height of the typical user, and wherein the distal end of the shaft carries a handlebar having a trigger attached thereto. The trigger serves as a means to actuate operation of the nail gun. The method of using an upright nail gun simply entails holding onto the handlebar, placing the barrel of the nail gun against a chosen surface, pulling the trigger and then bumping the head of the nail gun thereby releasing a nail.

A feature and advantage of the present invention is its ability to allow the user to operate a nail gun while in a standing position, thus reducing the likelihood of bodily injury.

A feature and advantage of the present invention is its ability to be manufactured to adjust in length to accommodate any user.

A feature and advantage of the present invention is its ability to accommodate a nail gun powered by air, electricity or any other powering means.

A feature and advantage of the present invention is its ease of use and operability.

A feature and advantage of the present invention is its ability to be attached to existing nail guns or to be formed integrally as a single unit.

These and other objects, features and advantages of the invention will become more apparent to one skilled in the art from the following descriptions and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures in which like reference numerals denote similar structures and refer like elements throughout, and in which:

FIG. 1 is a side view of an upright nail gun according to a preferred embodiment of the present invention.

FIG. 2 is a side view of an upright nail gun according to an alternate embodiment of the present invention showing an adjustable shaft.

FIG. 3 is a side view of an upright handle shown unattached to a nail gun according to an alternate embodiment of the present invention.

FIG. 3A is a top view of a bracket according to an alternate embodiment of the present invention.

FIG. 3B is a side view of a clamp according to an alternate embodiment of the present invention.

FIG. 4 is a side view of an upright handle shown attached to a nail gun according to an alternate embodiment of the present invention.

FIG. 4A is a side view of a hooking element according to an alternate embodiment of the present invention.

FIG. 5 is a side view of an upright handle shown unattached to a nail gun according to an alternate embodiment of the present invention.

FIG. 6 is a side view of an upright handle shown attached to a nail gun according to an alternate embodiment of the present invention.

### DETAILED DESCRIPTION OF THE PREFERRED AND ALTERNATE EMBODIMENTS

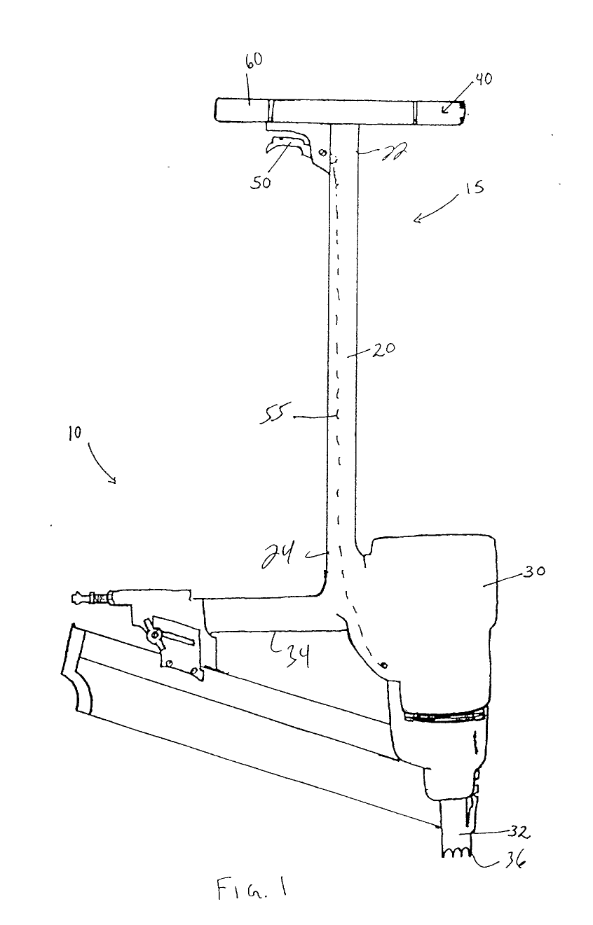

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar matter to accomplish similar functions.

Referring now to FIG. 1, the present invention in its preferred embodiment is a device 10, wherein device 10 is an upright nail gun. Device 10 generally comprises a handle assembly 15, a nail gun 30 and a trigger 50, wherein nail gun 30 is commonly known and available within the art.

Specifically, handle assembly 15 comprises a shaft 20 and a handlebar 40. Shaft 20 is preferably an elongated cylindrically-shaped member. The length of shaft 20 preferably approximates the waist height of the user of device 10, wherein the preferred length of shaft 20 is 30 inches and in alternate embodiments may range from 20 inches to 40 inches. In an alternate embodiment, shaft 20 could define other shapes such as, for exemplary purposes only, elongated rectangular or triangular, and can be formed from any known material such as, for exemplary purposes only, metal, plastic or composite.

Attached preferably to distal end 22 of shaft 20 is handlebar 40, wherein handle bar 40 is preferably cylindrically shaped and preferably comprises rubber gripping 60. Handle bar 40 is preferably welded to shaft 20 at distal end 22; however, shaft 20 can be attached to shaft 20 via any suitable attaching means known within the art such as, for exemplary purposes only, screws, bolts or integrally formed thereto. Handle bar 40 further preferably swivels so as to facilitate the positioning of nail gun 30 according to a user-specified position. In an alternate embodiment, handlebar 40 could define another shape such as, for exemplary purposes only, elongated rectangular, and can be formed from any material such as, for exemplary purposes only, plastic, metal or composite. Attached preferably to the opposing end of shaft 20 is nail gun 30, wherein nail gun 30 can be any type of powered nail gun known within the art such as, for exemplary purposes only, air-powered nail guns or electrically-powered nail guns. Nail gun 30 is preferably integrally formed to shaft 20 at proximal end 24; however, nail gun 30 may be attached to shaft 20 via any suitable attaching means such as, for exemplary purposes only, screws, bolts clamps or brackets.

To activate operation of nail gun 30, trigger 50 is attached preferably at the intersection of handlebar 40 and distal end 22 of shaft 20. Trigger 50 is preferably a pull-trigger mechanism mechanically linked or coupled to nail gun 30 via cable 55. In an alternate embodiment, trigger 50 may be electrically linked to actuate nail gun 30. However, other suitable alternate embodiments for trigger 50 can be utilized such as, for exemplary purposes only, spring-loaded push button mechanisms or any other known trigger mechanism. Additionally, it is contemplated that any known trigger safety mechanism may be incorporated with trigger 50.

In use, a user of device 10 would grasp handlebar 40 and position device 10 against a chosen surface to be nailed such that handlebar 40 and barrel 32 of nail gun 30 are preferably generally perpendicular to the surface, wherein trigger 50 is squeezed and wherein head 36 is bumped against the surface thereby causing a nail to be ejected therefrom.

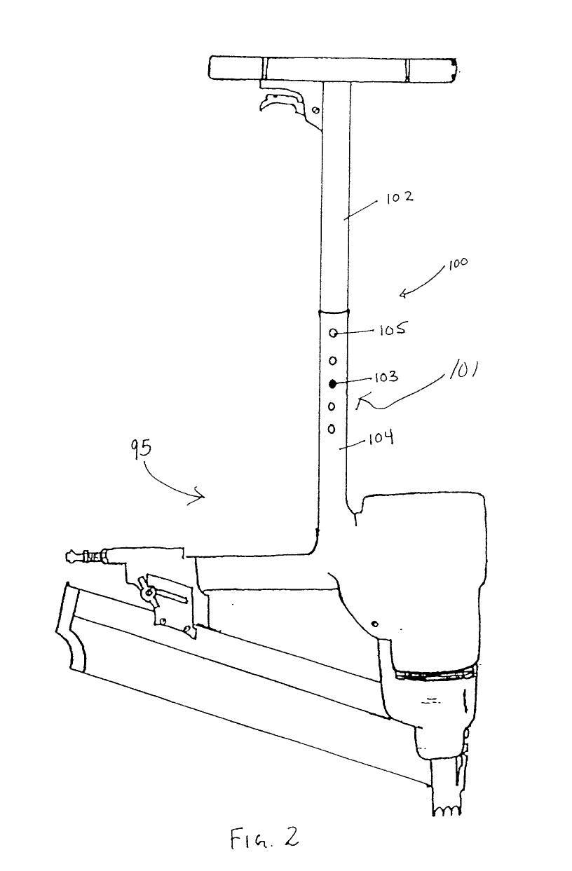

Referring now to FIG. 2, in an alternate embodiment, device 95 comprises an adjustable shaft 100, wherein adjustable shaft 100 is adjustable in length via manipulation of locking mechanism 101 of first member 102 and a second member 104, wherein second member 104 is dimensioned to slidably receive first member 102 such that first member 102 and second member 104 are telescoped. First member 102 has a spring-loaded lock-ball 103, and second member 104 comprises a plurality of equally spaced-apart longitudinal holes 105, wherein holes 105 are dimensioned to receive lock-ball 103. In order to adjust the length of adjustable shaft 100, a user of device 95 depresses spring-loaded lock-ball 103 and slides first member 102 through second member 104 either upward or downward until lock-ball 103 slips into a desired hole 105. Alternatively, adjustable shaft 100 could be adjusted by any other means known within the art such as, for exemplary purposes only, pneumatic mechanisms, frictional twist telescopic mechanisms or threaded extensions.

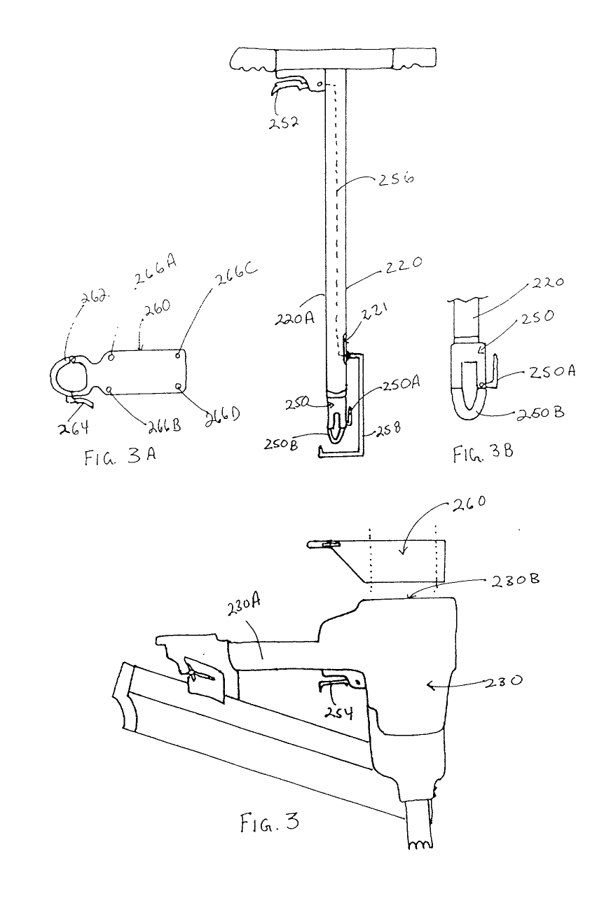

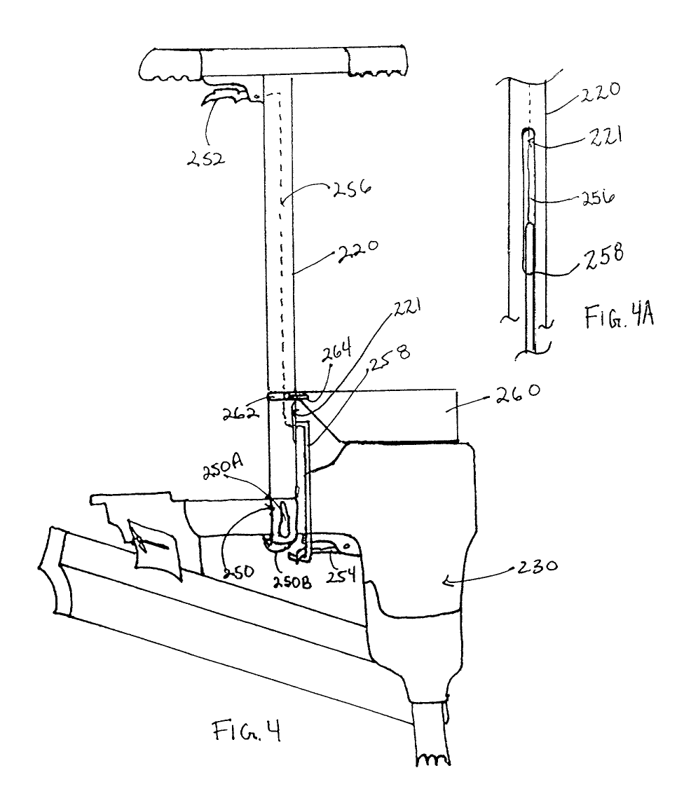

Referring now to FIGS. 3-4, in an alternate embodiment, shaft 220 is removably clamped to nail gun 230 via clamp 250. Clamp 250 is preferably tong-shaped and comprises securing loop 250B and locking latch 250A, wherein the unlocking of locking latch 250A allows securing loop 250B to swivel open, latch around handle area 230A of nail gun 230 and be secured thereto via relocking latch 250A. For overall stability, shaft 220 is secured within the confines of a bracket 260. Specifically, bracket 260 is a trapezoidal-shaped block having securing loop 262 and locking latch 264, wherein the unlocking of locking latch 264 allows securing loop 262 to swivel open, latch around shaft area 220A of shaft 220 and be secured thereto via relocking latch 264. Locking latch 264 and locking latch 250A are known and commercially available latches. Bracket 260 preferably further comprises throughholes 266A, 266B, 266C and 266D, wherein the insertion of screws of sufficient length therethrough secures bracket 260 to top area 230B of nail gun 230. Trigger 252 is mechanically coupled to activation switch 254 of nail gun 230 via cable 256 and hooking element 258, wherein hooking element 258 extends out from shaft 220 and is L-shaped to facilitate hooking over activation switch 254 of nail gun 230. Depressing trigger 252 forces hooking element 258 upward and allows activation switch 254 to be simultaneously depressed, thus activating nail gun 230. Upward movement of hooking element 258 is facilitated via hooking element 258 riding within slot 221 formed on shaft 220, as best depicted in FIG. 4A. Upon release of trigger 252, the weight of hooking element 258 allows hooking element 258 to return to its resting position. Alternatively, to facilitate return of hooking element 258 to a resting position, a spring-loaded return mechanism could be utilized, or cable 256 could be a weighted, rigid rod of fixed length so as to force hooking element 258 into a resting position upon release of trigger 252.

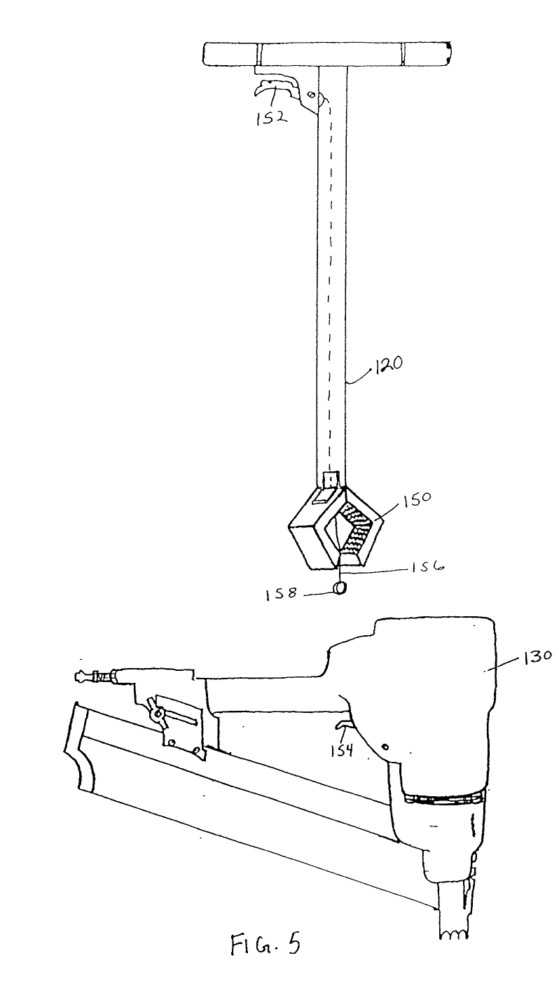

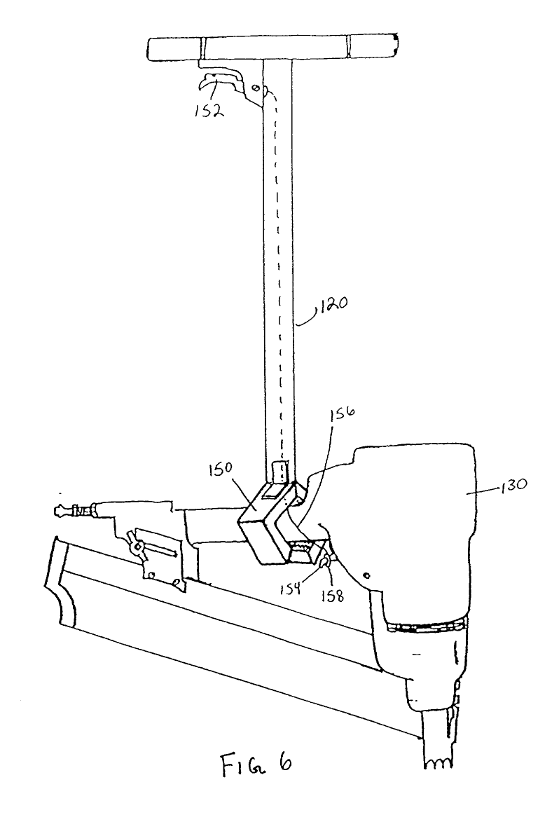

Referring now to FIGS. 5-6, in yet another alternate embodiment, shaft 120 is removably clamped to nail gun 130 via clamp 150. Clamp 150 can be any type of clamping means known within the art such as, for exemplary purposes only, spring loaded clamps or clamps comprising flexibly tensioned metal strips. Trigger 152 is mechanically coupled to activation switch 154 of nail gun 130 via cable 156 and hooking element 158. Hooking element 158 can be any type of hooking means known within the art such as, for exemplary purposes only, rings or hooks.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An upright nail gun, comprising:
a handle assembly having at least one elongated shaft and a handle bar, said at least one elongated shaft having a proximal end and a distal end, said handle bar attached to said distal end of said at least one elongated shaft;
a trigger carried by said handle bar; and
a nail gun carried at said proximal end of said at least one elongated shaft, wherein said trigger is linked to said nail gun such that the squeezing of said trigger activates said nail gun.

2. The upright nail gun of claim 1, wherein said trigger is mechanically coupled to said nail gun to actuate the release of a nail from said nail gun.

3. The upright nail gun of claim 1, wherein said trigger is electrically coupled to said nail gun to actuate the release of a nail from said nail gun.

4. The upright nail gun of claim 1, wherein said shaft further comprises a means for adjusting the length of said shaft.

5. The upright nail gun of claim 4, wherein said means for adjusting the length of said shaft is a pneumatic mechanism.

6. The upright nail gun of claim 4, wherein said means for adjusting the length of said shaft is a frictional telescopic mechanism.

7. The upright nail gun of claim 4, wherein said means for adjusting the length of said shaft is a threaded extension.

8. The upright nail gun of claim 4, wherein said means for adjusting the length of said shaft is a spring-loaded lock-ball-and-hole mechanism.

9. A handle assembly for attachment to a nail gun, comprising:
at least one elongated shaft, said at least one elongated shaft having a proximal end and a distal end, wherein said distal end has a handle bar attached thereto and said proximal end has a nail gun attached thereto; and
a trigger carried by said handle bar.

10. The handle assembly of claim 9, wherein said proximal end of said at least one elongated shaft is removably secured to said nail gun via clamping means.

11. The handle assembly of claim 9, wherein said proximal end of said at least one elongated shaft is removably secured to said nail gun via bracketing means.

12. The handle assembly of claim 9, wherein said proximal end of said at least one elongated shaft is removably secured to said nail gun via bolts.

13. The handle assembly of claim 9, wherein said proximal end of said at least one elongated shaft is removably secured to said nail gun via screws.

14. The handle assembly of claim 9, wherein said proximal end of said at least one elongated shaft is integrally formed with said nail gun.

15. The handle assembly of claim 9, wherein said trigger further comprises a safety switch.

16. The handle assembly of claim 9, wherein said at least one elongated shaft has a plurality of lengths.

17. The handle assembly of claim 10, wherein said clamping means is a spring loaded clamp and wherein said trigger is mechanically coupled to an activation switch on said nail gun.

18. The handle assembly of claim 10, wherein said clamping means is a clamp comprising flexibly tensioned metal strips and wherein said trigger is mechanically coupled to an activation switch on said nail gun.

19. The handle assembly of claim 10, wherein said bracketing means is a spring loaded bracket and wherein said trigger is mechanically coupled to an activation switch on said nail gun.

20. The handle assembly of claim 10, wherein said bracketing means is a bracket comprising flexibly tensioned metal strips and wherein said trigger is mechanically coupled to an activation switch on said nail gun.

21. The handle assembly of claim 10, wherein said clamping means is a securing loop lockable via a latch and wherein said trigger is mechanically coupled to an activation switch on said nail gun.
